(19) United States
(12) Patent Application Publication
(10) Pub. No.: US 2022/0050956 A1
(43) Pub. Date: Feb. 17, 2022

(54) CONTEXT SPECIFIC DOCUMENT RECOMMENDATION SYSTEM FOR AUTOMOTIVE RETAIL

(71) Applicant: TEKION CORP, San Ramon, CA (US)

(72) Inventors: Gaurav Gupta, Chandigarh (IN); Abhinandan Sahgal, Bangalore (IN); Justin Alexander Chi-Young Hou, Pleasanton, CA (US)

(21) Appl. No.: 16/994,430

(22) Filed: Aug. 14, 2020

(51) Int. Cl. G06F 40/174; G06F 16/16; G06Q 20/40

(52) U.S. Cl. CPC G06F 40/174; G06Q 20/4014; G06Q 20/405; G06F 16/168

(57) ABSTRACT

A document recommendation system provides a set of documents to a user to complete an automotive transaction between an automotive dealership and a customer. The system stores documents for completing automotive transactions over a wide range of transaction attributes. The store includes base documents and secondary documents. Base documents are used for all transactions. Secondary documents are transaction specific and are based on attribute details of the transaction. After the transaction attributes are received, the system selects a set of base documents and a set of secondary documents. The system may select the secondary documents according to a predefined set of rules. After both sets of documents are selected, the system populates fields of the documents with values using the received transaction attributes. The populated documents are then provided to the user of the document recommendation system for review.

### BACKGROUND

### Field of Disclosure

The present disclosure generally relates to completing an automotive transaction at an automotive dealership, and specifically, to a context specific document recommendation system used to complete the automotive transaction.

### Description of the Related Art

An automotive transaction between a customer and an automotive dealership can involve a myriad of products and services, such as vehicles, vehicle accessories, financial products, protection products (e.g., insurance products and warranties), etc. Historically, to perform an automotive transaction at an automotive dealership, an employee of the dealership was required to retrieve a set of documents to complete the transaction. Due to the number of different products and services that can be involved in automotive transactions, automotive transactions can require a number of different documents and the documents can vary depending on the context of the transaction. Thus, completing an automotive transaction is tedious, can be time consuming, and requires the employee to have an extensive knowledge of the specific documents required to complete automotive transactions. Furthermore, due to the number of documents required to complete automotive transactions, conventional automotive transaction systems that require an employee of the dealership to manually select the documents required to complete the automotive transaction is vulnerable to errors. For example, by selecting an incorrect document or omitting a document, the employee may inadvertently render the transaction incomplete or inaccurate.

### SUMMARY

Embodiments relate to a context aware document recommendation system that recommends documents to complete a transaction. The documents allow a user (e.g., an employee of an automotive dealership or a customer) or an automated system (e.g., shopping website) to complete an automotive transaction between the automotive dealership and a customer of the automotive dealership, for example. To select a set of documents for completing the transaction, the recommendation system receives transaction attributes. Transaction attributes describe details of the transaction. For example, the attributes describe a transaction type of the transaction (e.g., selling, leasing, renting, or buying) and details of the vehicle being purchased by the customer (e.g., price).

In one embodiment, the document recommendation system stores documents that may be used for completing an automotive transaction such as a vehicle transaction over a wide range of transaction attributes. The store includes base documents and secondary documents. In one embodiment, base documents are used for all transactions. In contrast, secondary documents are transaction specific and are based on one or more attribute details of the automotive transaction. Said differently, a selected set of secondary documents are tailored for a specific automotive transaction. For example, if a customer is purchasing a vehicle, a secondary document may be a waiver form associated with the make and model of the vehicle.

After the transaction attributes are received, the system selects a set of secondary documents based on the attributes and a set of base documents. The system may select the secondary documents according to a predefined set of rules. After both sets of documents are selected, the system populates fields of the documents with values using the received transaction attributes. The populated documents are then provided to a user of the system for review. If the selected documents and the populated values are satisfactory, the documents may be used to complete the automotive transaction.

In one embodiment, a group of distinct transaction documents for completing automotive transactions at the automotive dealership are stored. Attributes of an automotive transaction of a vehicle from the automotive dealership are received from a user (e.g., from an employee of the automotive dealership or a customer). The attributes describe a type of transaction associated with the automotive transaction. A set of base transaction documents required to complete the automotive transaction are selected from the group of distinct transaction documents. The set of base transaction documents is selected irrespective of the attributes of the automotive transaction. A set of transaction specific documents from the group of distinct transaction documents is selected based on the attributes of the automotive transaction. The set of base transaction documents and the set of transaction specific documents are provided, for example, to the employee of the automotive dealership. Fields of the set of base transaction documents and the set of transaction specific documents are filled with values.

The methods and systems described herein are described in the context of automotive transactions. Automotive transactions can include transactions related to vehicles as well as protection products (e.g., insurance products and warranties), vehicle accessories or parts, financial products, etc.

The above and other needs are met by a computer-implemented method, a non-transitory computer-readable storage medium storing executable code, and a system including one or more processor and a computer-readable storage medium comprising executable computer program code.

### BRIEF DESCRIPTION OF DRAWINGS

FIG. 1 is a high-level block diagram illustrating a system environment in which a dealership system operates, according to one embodiment.

FIG. 2 is a high-level block diagram illustrating a detailed view of a dealership system, according to one embodiment.

FIG. 3 is a high-level block diagram illustrating types of documents stored in a document store, according to one embodiment.

FIGS. 4-8 illustrate screens of a user interface (UI) of a document recommendation system, according to some embodiments.

FIG. 9 is a flowchart illustrating a method of completing an automotive transaction at an automotive dealership, according to one embodiment.

FIG. 10 is a diagram illustrating a computer system upon which embodiments described herein may be implemented according to some embodiments.

### DETAILED DESCRIPTION

The Figures (FIGS.) and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that similar or like reference numbers may be used in the figures and may indicate similar or like functionality.

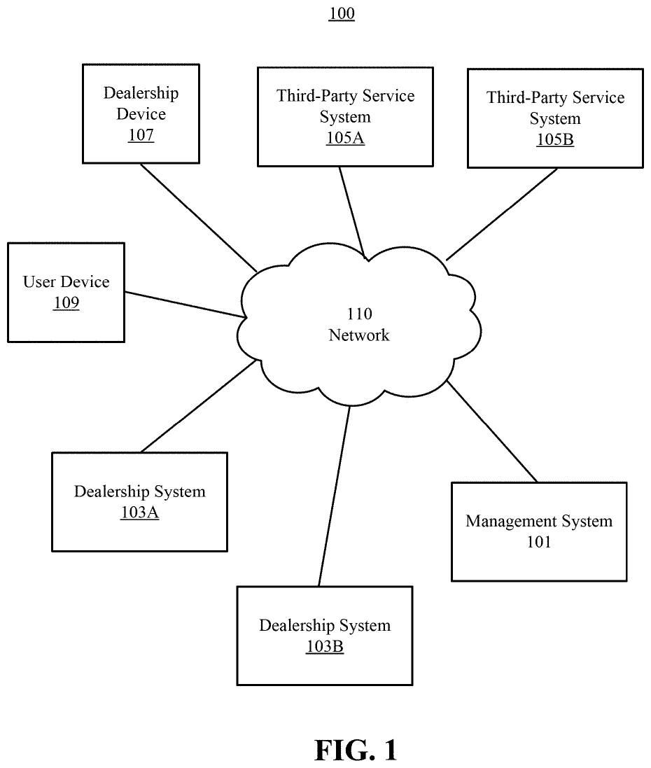

FIG. 1 is a high-level block diagram illustrating a system environment 100 in which a dealership system 103 operates, according to one embodiment. While the embodiments herein are described with respect to the context of automotive dealerships, the techniques described herein are applicable to any context where an automotive transaction may take place. An automotive transaction can involve a myriad of products and services, such as vehicles, vehicle accessories, financial products, protection products (e.g., insurance products and warranties), etc. While the description herein is described with respect to automotive transactions, the embodiments herein are applicable to the various products and services that may be involved in automotive transactions.

In one embodiment, the environment 100 includes a management system 101, a dealership system 103A, a dealership system 103B, a third-party service system 105A, a third-party service system 105B, a dealership device 107, and a user device 109 connected to each other via a network 110. While only two instances of dealership systems 103, two instances of third-party services systems 105, and a single instance of each of the dealership device 107 and user device 109 are shown, there may be multiple instances of each of these different entities.

The network 110 provides a communication infrastructure between the entities included in environment 100. The network 110 is typically the Internet, but may be any network, including but not limited to a Local Area Network (LAN), a Metropolitan Area Network (MAN), a Wide Area Network (WAN), a mobile wired or wireless network, a private network, or a virtual private network.

In one embodiment, a dealership system 103 is representative of an automotive dealership that buys and sells vehicles (new or used) at the retail level based on a dealership contract with an automotive manufacturer (e.g., GM, FORD, TOYOTA, BMW, etc.). The dealership system 103 may also perform services on vehicles owned by customers of the dealership system 103. The services may include basic maintenance such as an engine oil change, brake pad replacement, brake rotor replacement, brake fluid replacement, transmission oil change, etc. as well as more complex services such as engine rebuild services or suspension overhaul services. However, the services that may be performed by the dealership system 103 are not limited to those described herein.

The dealership system 103 also may sell other products to its customers than vehicles. For example, the automotive system 103 may also sell original equipment manufacturer (OEM) parts for vehicles sold by the dealership system 103 as well as automotive related accessories. Examples of the automotive related accessories include hats, license plate frames, floor mats, key chains, wiper blades, etc. In another example, the automotive system 103 also sells financing, insurance, and warranty products.

As shown in FIG. 1, the environment 100 includes dealership system 103A and dealership system 103B. Each dealership system 103 is representative of a different automotive dealership. The different dealership systems 103 shown in FIG. 1 may represent automotive dealerships selling different makes of vehicles. For example, dealership system 103A may represent a particular instance of a GM dealership whereas dealership system 103B may represent a particular instance of a TOYOTA dealership. In another embodiment, the different dealership systems 103 shown in FIG. 1 may represent two different automotive dealerships selling the same make of vehicles. For example, dealership system 103A and 103B are different automotive dealerships that both sell GM vehicles.

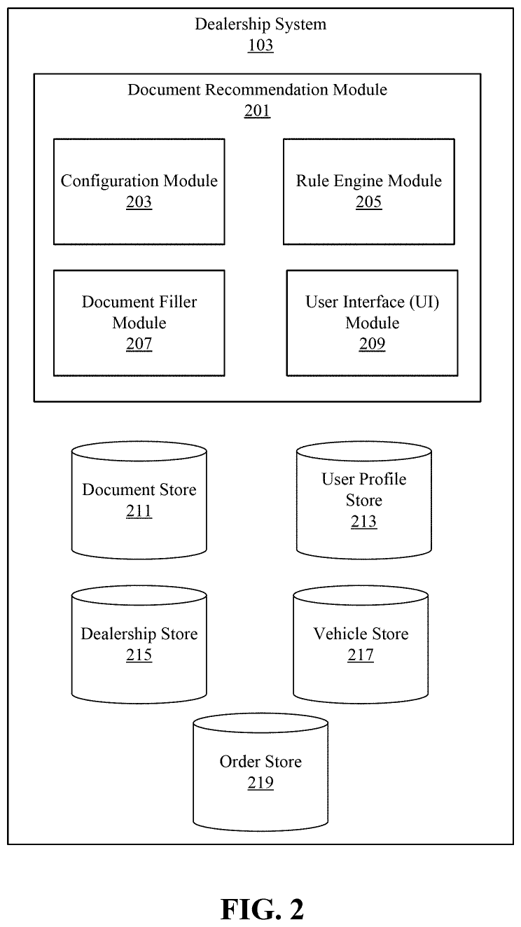

In one embodiment the management system 101 provides services and documents to one or more dealership systems 103. For example, the management system 101 provides a dealership system 103 with one or more documents for completing automotive transactions. In one embodiment, the management system 101 hosts one or more modules and/or stores of the dealership system 103 (described with respect to FIG. 2). This may allow the dealership system 103 to access the modules and stores (e.g., via the network 110) without storing and running the modules or stores locally at the dealership system 103. For example, an employee of a dealership system 103 can access one or more documents stored on the management system 101 by logging onto the management system 101 through the network 110.

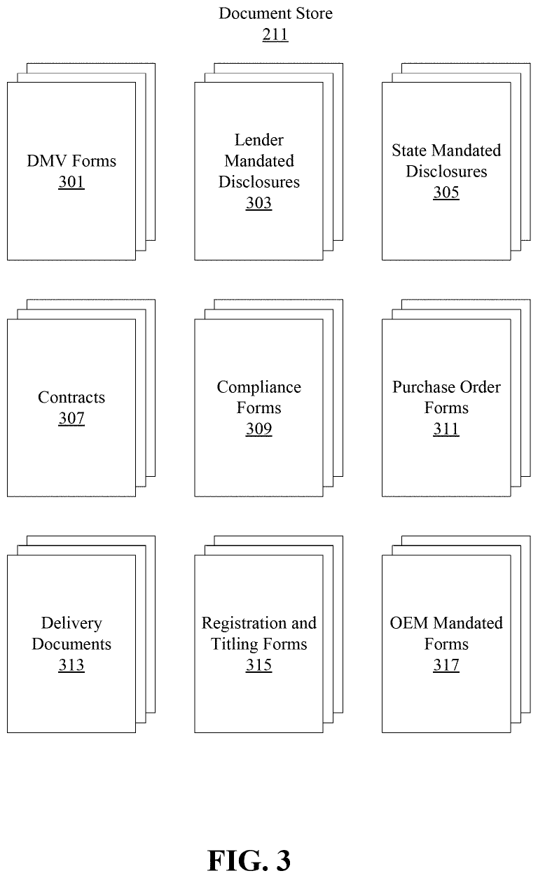

A third-party service system 105 is a document provider system that generates and provides documents for completing an automotive transaction in one embodiment. Examples of document providers include a bank that works with the dealership system 103B to finance vehicle purchases made through the dealership system 103B. Examples of documents that may be provided by a bank include an application for a line of credit and a credit check authorization form. Another example of a document provider is the Department of Motor Vehicles (DMV). The DMV may provide forms required to register a vehicle purchased at the dealership system 103B, lien documents, and/or title documents. Another example of a document provider is a credit bureau. A dealership system 103 and/or the management system 101 may retrieve documents (and information) from a third-party service system 103 and store them in a document store as described further with respect to FIGS. 2 and 3.

In one embodiment, a dealership device 107 and the user device 109 are computing devices such as smartphones with an operating system such as ANDROID® or APPLE® IOS®, tablet computers, laptop computers, desktop computers, or display monitors. Typical dealership devices 107 and user devices 109 include the hardware and software needed to input and output sound (e.g., speakers and microphone) and images, connect to the network 110 (e.g., via Wifi and/or 5G or other wireless telecommunication standards), determine the current geographic location of the dealership devices 107 and user devices 109 (e.g., a Global Positioning System (GPS) unit), and/or detect motion of the dealership devices 107 and user devices 109 (e.g., via motion sensors such as accelerometers and gyroscopes).

In one embodiment, a user device 109 is the personal device of a customer of the dealership system 103. The user device 109 may be used by a customer to remotely participate in an automotive transaction. For example, a customer not physically located at a dealership system 103 completes a vehicle loan application using the user device 109. In one embodiment, the loan application is then sent to the dealership system 103 and an employee of the dealership system 103 (or customer) uses the loan application to complete an automotive transaction. In contrast, a dealership device 107 is a device owned by the dealership system 103 and is typically located at the dealership system 103. The dealership device 107 may be used by an employee of the dealership system 103 during a customer intake process at the dealership system 103.

FIG. 2 is a high-level block diagram illustrating a detailed view of a dealership system 103, according to one embodiment. In one embodiment, the dealership system 103 includes a document recommendation module 201, a document store 211, a user profile store 213, a dealership store 215, a vehicle store 217, and an order store 219. The order store contains sales orders, services orders, and part orders. The document recommendation module 201 includes a configuration module 203, a rule engine module 205, a document filler module 207, and a user interface (UI) module 209 in one embodiment. Note that in other embodiments, the dealership system 103 may include other modules and/or databases than those illustrated in FIG. 2.

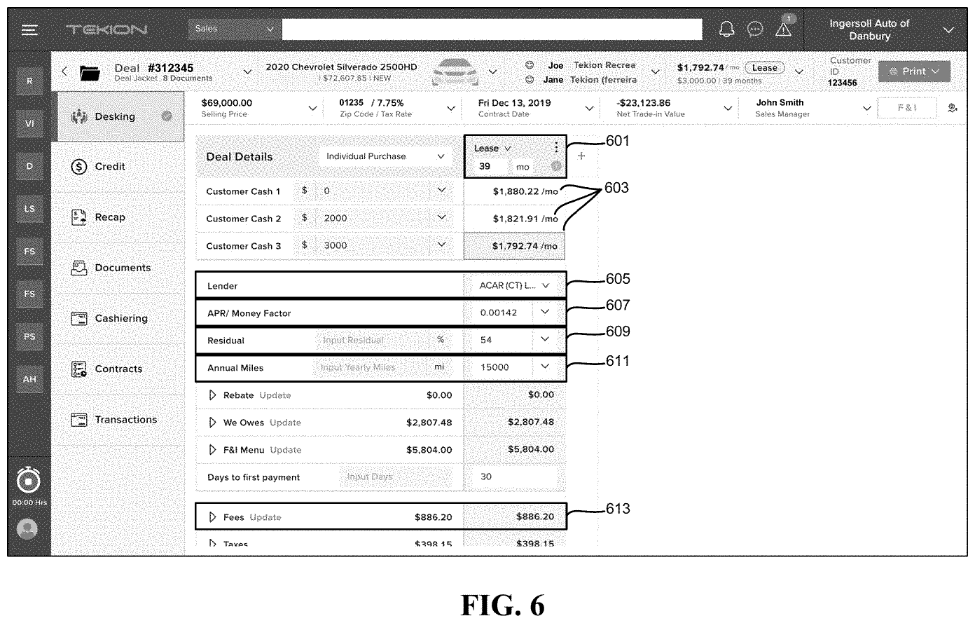

In one embodiment, the document recommendation module 201 receives input for an automotive transaction from a user (e.g., from an employee of the dealership system 103 or by the customer). An automotive transaction may be a customer purchasing or leasing a vehicle from the dealership system 103 or selling a vehicle to the dealership system 103. An automotive transaction may be a customer returning a purchased or leased vehicle, the dealership system 103 acquiring a vehicle (referred to as a “street purchase), or the dealership system 103 auctioning a vehicle. In one embodiment, a transaction does not include a vehicle but does includes a product associated with a vehicle, such as a warranty or insurance product. The document recommendation module 201 may receive input via a UI (e.g., see FIG. 6). The document recommendation module 201 may also receive input for an automotive transaction from the user profile store 213, the dealership store 215, and the vehicle store 217. For example, as described below, the stores 213, 215, 217 may store information (such as a customer's name and address) that can be used as input (or a portion of input) for an automotive transaction so that the input may not need to be received entirely via the UI.

An example of a type of input received by the document recommendation module 201 is a transaction attribute (also referred to as transaction data or transaction information). Transaction attributes describe details of a automotive transaction. Transaction attributes may include a transaction type that describes the type of automotive transaction, such as purchasing, leasing, or selling a vehicle. Transaction attributes may include a type of payment used for purchasing the vehicle, such as financing or paying cash. Transaction attributes may also include customer information, such as the customer's name, age, address, contact information, employment information, salary information, etc. Transaction attributes may also include information associated with insurance products, accessories, and/or trade-in vehicles. Transaction attributes may also include attributes of a stage of the transaction, such as a cancelation of the transaction. Transaction attributes may also include transaction classifications, such as personal, business, wholesale, dealer trade, and only finance and/or insurance product sale.

Transaction attributes may include vehicle information of the vehicle associated with the automotive transaction, such as a make, model, year, status of the vehicle (e.g., new or used), mileage, vehicle identification number (VIN), vehicle weight, fuel type (e.g., gas, diesel, hybrid, electric, hydrogen), or history of the vehicle. If the automotive transaction is a trade-in transaction, the vehicle information may include information about the customer's asset that is being traded into the dealership system 103. For example, if the asset is a vehicle, the information may include the make, model, year, and mileage of the customer's vehicle. Other example assets that may be traded-in other than a vehicle include motorcycles, boats, animals, equipment, etc. Assets traded in other than vehicles may be eligible for a tax credit.

Transaction attributes may include purchasing information, such as a price of the vehicle, a tax rate, and fees associated with the transaction. If the customer is financing the vehicle, transaction attributes may include financing information, such as an interest rate, term length, minimum monthly payment, start date, end date of a loan, and name and representative of the financial institution that is funding the loan for the vehicle. If the customer is leasing the vehicle, transaction attributes may include leasing information, such as a lender, capitalization cost, capitalized cost reduction, adjusted capitalized cost, acquisition fee, depreciation value, residual, money factor, security deposit amount, disposition charge, term length, monthly payment, and mileage limitations. Transaction attributes may include a delivery option, such as a pick-up date or delivery date. Transaction attributes may include dealership information, such as a type of the dealership and the location of the dealership. In some cases, transaction attributes include discretionary money or credits that may be applied to the transaction.

After the input for the automotive transaction is received, the document recommendation module 201 may recommend a set of automotive transaction documents to an employee of the dealership system 103. In one embodiment, the automotive transaction documents are used to complete a transaction between an automotive dealership and a customer. The set of automotive transaction documents may be automatically selected and fields of the automotive transaction documents filled (i.e., completed) with values by the document recommendation module 201 based on the received input. The document recommendation module 201 may also be referred to as a document recommendation system.

Among other advantages, the document recommendation system provides context specific documents. In other words, the selected documents are tailored to a specific transaction. Due to this, an employee of the dealership system 103 may no longer be required to memorize which documents are required for each unique set of transaction attributes to complete automotive transactions. Due to the large number of transaction attributes, the number of combinations of documents needed to complete different automotive transactions may be difficult or impossible to remember. The document recommendation module 201 thus alleviates the burden on the employee of the dealership system 103 (or a customer) from memorizing and individually selecting documents for automotive transactions. As a result, the recommendation system allows the employee or customer to quickly, efficiently, and intuitively complete an automotive transaction.

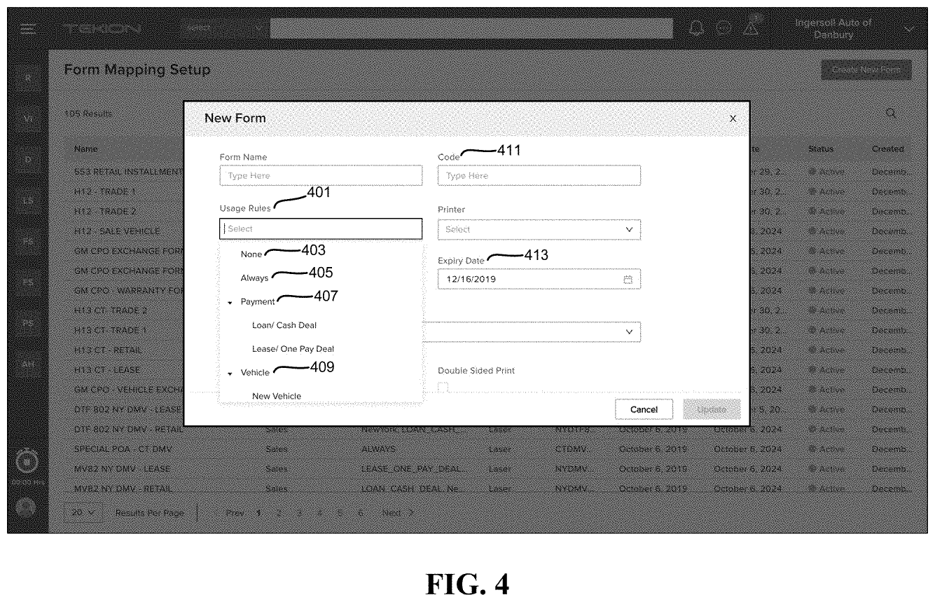

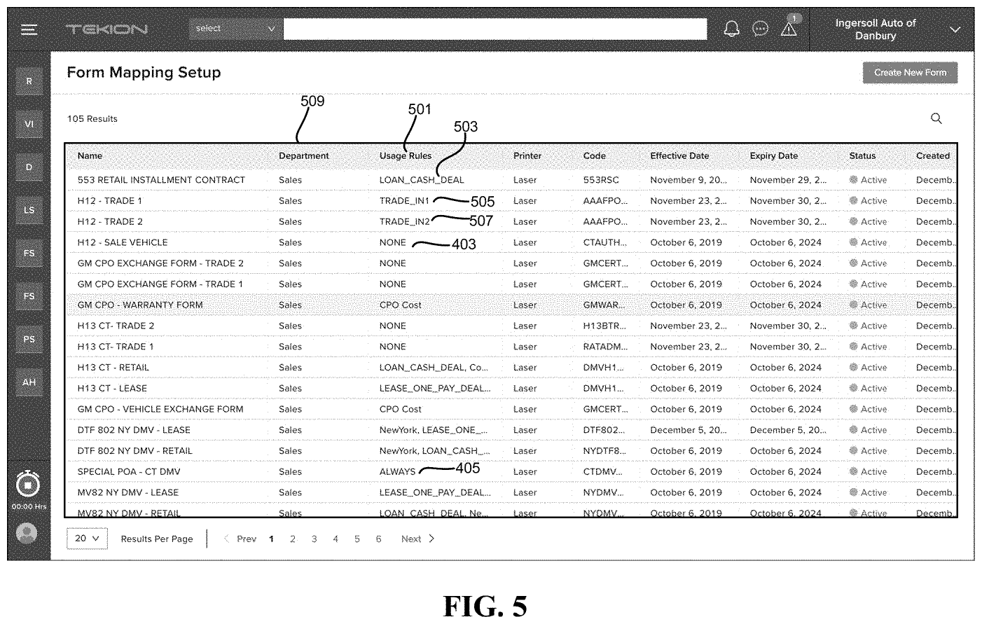

Referring to the modules of the document recommendation module 201, in one embodiment, the configuration module 203 configures the document recommendation module 201. For example, as further described below, the configuration module can add documents to the document store 211 and establish document selection rules for documents in the document store 211. The document recommendation module 201 may be configured manually (e.g., by an employee of a dealership system 103) or automatically via the configuration module 203. An employee may provide configuration instructions to the configuration module 203 via a UI (e.g., see FIGS. 4 and 5 and related descriptions). The configuration module 203 may be used to initially set up the document recommendation module 201 and later used to modify the document recommendation module 201.

In one embodiment, the configuration module 203 can edit (e.g., add, delete, and modify) documents in the document store 211. Since documents required to complete an automotive transaction may change over time, documents in the document store 211 may need to be replaced or modified for the document store 211 to be up-to-date. For example, one or more documents may be updated due to changes in automotive transaction laws. In another example, an organization, such as a third-party service system 105 or the dealership system 103, may reformat or update its forms, e.g. the “Application for Duplicate or Transfer of Title” form from the DMV is modified. To keep the document store up-to-date, the configuration module 203 may update documents in the document store 211. For example, the configuration module may periodically retrieve new documents from a from third-party service system 105 (e.g., once a year) or receive new documents from a user, such as an employee of a dealership system 103, or from the management system 101.

The configuration module 203 may establish and modify rules for selecting a document and rules for populating fields of a document, for example, after a new document is added to the document store 211. Rules may be established for each document or rules may specify documents to be selected (e.g., for a given attribute). In one embodiment, rules are established for documents not stored in the document store 211. For example, a rule is established for a document that is provided by a third-party system 105 during a transaction. As previously described, examples of a third-party system 105 include banks, third-party data providers, or a registration system (e.g., DMV). The rules may be established manually or automatically, and the rules may be stored in the rule engine module 205 or the document filler module 207. Regarding rules for selecting a document, the configuration module 203 may establish a rule for a document that specifies in which context the document should be selected for a transaction. In other words, the rule specifies which transaction attributes indicate that the document should be selected for use in the transaction.

Regarding rules for populating fields of each document stored in the document store 211, in one embodiment the configuration module 203 identifies one or more fields of the document and associates the identified fields with types of data that may be received (e.g., via the UI module 209) to complete the fields. For example, the configuration module 203 identifies a name field and an address field in a document and associates those fields with name and address input fields of the UI. In one embodiment, the configuration module 203 specifies types of characters that can be received for each field. For example, a name field receives alphabetical characters and an address field receives alphanumeric characters.

FIGS. 4 and 5 illustrate examples UI screens for interacting with the configuration module 203, according to some embodiments. FIG. 4 illustrates an interface for adding a new document to the document store 211. In the UI, a user (e.g., an employee of the dealership system 103) can configure one or more rules associated with the new document. For example, the drop-down menu under “Usage Rules” 401 allows the user to select a selection rule to be associated with the document. “None” 403 may be selected to signify that the document should not be associated with any selection rule. “Always” 405 may be selected to signify that the document is a base document. “Payment” 407 may be selected to signify that the document should be selected based on a payment type associated with a transaction and whether the payment is a loan/cash deal or a lease/one pay deal. “Vehicle” 409 may be selected to signify the document should be selected based on vehicle information (e.g., new or used). A user may also be able to provide an identification code 411 that represents an identification number of the document and set an expiration date 413 for the document so that the document is removed or no longer usable after the specified date.

FIG. 5 illustrates a list of documents 509 stored in the document store 211. By selecting a document in the list 509, a user can edit the document and edit any rules associated with the document. Text in the column under “Usage Rules” 501 indicates selection rules (if any) associated with the documents. For example, “LOAN_CASH_DEAL” 503 indicates a document should be selected if transaction attributes include a financing payment type. Similarly, “TRADE_IN1” 505 and “TRADE_IN2” 507 indicate that a document should be selected if the transaction attributes indicate the customer is trading in a vehicle.

Referring back to FIG. 2, in one embodiment, the UI module 235 provides instructions (e.g., code) for generating and rendering a UI for presentation on a display, such as a monitor or a user device 109. The UI is a software interface that enables a user (e.g., an employee of a dealership system 103) to view and interact with the document recommendation module 201. Example screens of a UI generated by the UI module 209 are illustrated in FIGS. 4-8 and are further described below.

In one embodiment, the document store 211 stores transaction documents that may be used to complete an automotive transaction between an automotive dealership and a customer. The document store 211 may be located on a local computing machine or may be stored across multiple computing machines associated with the dealership system 103. The document store 211 stores base documents and secondary documents. In one embodiment, base documents are used for all transactions regardless of transaction attributes of the transaction. An example of a base document is a federal compliance form (e.g., related to the handling of a customer's personal information). Another example of a base document is a federal form for electronic signature (ESIGN), for example to allow for digital signatures. In contrast, secondary documents are transaction specific and are based on the attribute details of the transaction (secondary documents may also be referred to as transaction specific documents).

FIG. 3 illustrates example types of documents that may be stored in the document store 211. These example documents include DMV forms 301, lender mandated disclosures 303, state mandated disclosures 305, contracts 307, compliance forms 309, purchase order documents 311, delivery documents 313, registration and titling forms 315, and original equipment manufacturer (OEM) mandated dorms 317. The document store 211 may store additional, fewer, or different documents than those illustrated in FIG. 3. For example, the document store can include privacy forms, federal forms (e.g., ESIGN forms), dealership forms, vehicle forms, accessory purchase forms, insurance or protection forms, rebates and incentive forms, and trade-in vehicle forms.

DMV forms 301 are forms provided by the DMV for selling, purchasing, or titling a vehicle and should be filed with the DMV. Lender mandated disclosure documents 303 are associated with a loan or lease (e.g., a state specific 553 contract). If the customer is financing or leasing the vehicle, a lender mandated disclosure form 303 may inform the customer of details of the loan or lease (e.g., the start date, term length, and monthly payments). State mandated disclosures 305 are automotive transaction disclosures associated with a state or region (e.g., where the dealership is located). For example, a state disclosure form 305 is a document issued by a state that informs the customer of the dangers of driving a vehicle. A contract 307 is an agreement between two parties, such as the customer and the dealership. Compliance forms 309 describe a customer's rights associated with the automotive transaction in view of federal and state regulations. Compliance forms 309 may also describe policies and actions of the dealership system 103 that demonstrate the dealership system 103 complies with federal and state regulations. A purchase order form 311 provides a list of one or more products (e.g., a vehicle) that a customer would like to purchase via the transaction. Delivery documents 313 describe how a vehicle will be delivered to the customer. Registration and titling forms 315 register the vehicle and transfer the title of ownership of the vehicle to one or more parties. Registration and titling forms 315 may also be considered DMV forms 301. OEM mandated forms 317 are documents from manufacturers of parts of the vehicle. OEM forms can also include forms to sign up for OEM services. The document store 211 may also include finance documents that are institution specific (e.g., if the customer finances the transaction through a credit union, the customer may need to fill out a membership form) and forms associated with prepaid accessories or services (sometimes referred to as a “Due Bill” or “We Owe”). These forms describe services or items owed to the customer because they were prepaid.

Referring back to FIG. 2, in one embodiment, the rule engine module 205 receives input (e.g., transaction attributes) provided to the document recommendation module 201 and selects documents from the document store 211 to recommend based on the input according to the selection rules that are applicable to the transaction attributes. As previously stated, the input may be received from a user via the UI. Input my additionally or alternatively be received by a customer. The selected set of documents includes any number of base documents and secondary documents. Since base documents are not based on input, the base documents may be selected before the input is received. In one embodiment, the transaction is updated in real time. If any changes are made, the rule engine 205 may revise the selected documents according to the latest changes.

In one embodiment, the rule engine 205 receives transaction attributes associated with an automotive transaction. An example user interface for providing transaction attributes is illustrated in FIG. 6. FIG. 6 includes input fields associated with leasing information, such as the lease term length 601, possible monthly payments 603 depending on the cash paid by the customer at the time of signing of the lease, lender 605 that describes the bank that will finance the lease, money factor 607, residual 609, annual mileage limits 611, fees 613, etc. Using the received transaction attributes, the rule engine 205 references rules associated with the transaction attributes and selects secondary documents according to the referenced rules.

For example, the rule engine 205 identifies a transaction type in the transaction attributes (e.g., a lease), references one or more rules associated with identified transaction type, and selects one or more secondary documents associated with the identified transaction type. In another example, since different states may have different laws associated with completing an automotive transaction, the rule engine 205 identifies the state the dealership system 103 is located in (e.g., specified in the transaction attributes), references one or more rules associated with the identified state, and selects one or more secondary documents required to complete an automotive transaction in that state. In another example, if the transaction type is a trade-in, the rule engine 205 references one or more rules associated with a trade-in and selects additional forms specific to this transaction type, such as a power of attorney (e.g., to request a duplicate title from the DMV) and a DMV form for vehicle reassignment.

In one embodiment the rule engine 205 compares a current transaction with previous transactions to recommend additional documents. The rule engine 205 may compare the received input (e.g., transaction type) for a current transaction with input from previous transactions to find similar transactions. If a previous transaction includes similar input as the current transaction, the rule engine 205 may cross check documents selected for the current transaction with documents selected for the past transaction. Document discrepancies across similar transactions may occur due to one or more documents not being associated with a selection rule or to a user manually adding or subtracting documents in a transaction. Based on the documents selected for past transactions, the rule engine 205 may recommend one or more documents to be added to or removed from the current transaction. This may be helpful for documents that are not required to complete the transaction but may be beneficial to the user or the customer (e.g., a document related to a current sales promotion or to extending a warranty). This may also help the dealership system 103 to maintain consistency across transactions.

In one embodiment, if document discrepancies across similar transactions are consistently recognized (e.g., after a threshold number of identical or similar discrepancies are recognized), the rule engine 205 or configuration module 203 may automatically suggest a new rule or rule update. In some cases, the rule engine 205 or configuration module 203 automatically establishes a new rule or updates a preexisting rule. Among other advantages, this keeps the document recommendation module 201 relevant and up to date.

In one embodiment, the document filler module 207 receives the transaction attributes and the documents selected by the rule engine module 205. The document filler module 207 uses the transaction documents to populate fields of the selected documents. The fields may be filled in using predefined rules for completing the documents (e.g., as described with respect to the configuration module 203). In some cases, documents may need a document ID number. For these documents, the document filler module 207 may communicate with a third-party system 105 to dynamically generate a document ID number.

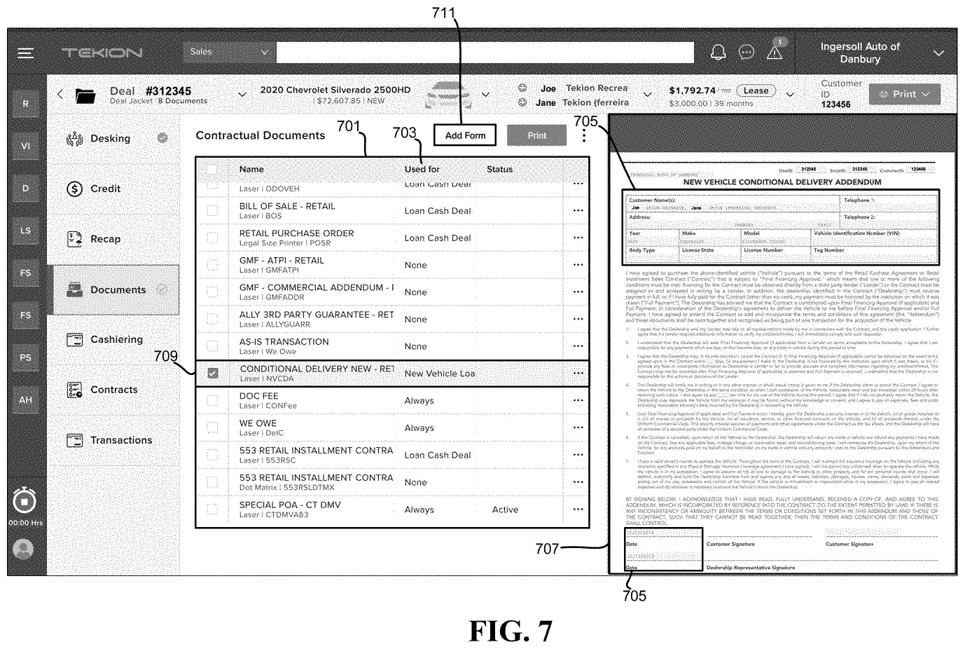

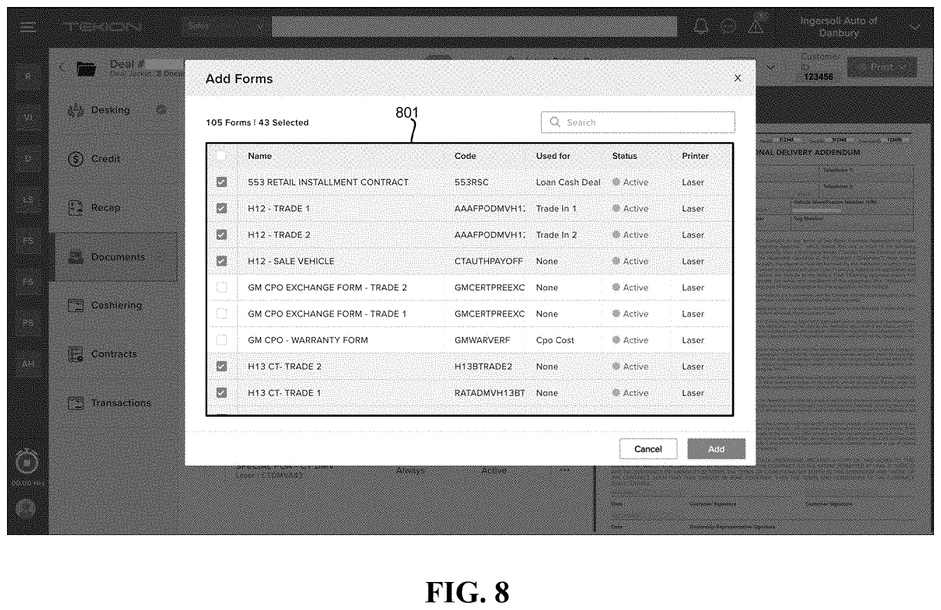

FIG. 7 illustrates an example UI that includes a list of documents 701 selected by the rule engine 205 and modified by the document filler module 207. Text in the column under “Used For” 703 indicates transaction attributes that each document is associated with. Fields 705 of the documents may be automatically filled in (e.g., except for the signature fields) based on the transaction attributes. The UI in FIG. 7 includes a preview region 707 that allows the user to review a selected document 709. For example, the UI allows the user to edit information in the fields of the selected document 709. Furthermore, if the list of documents 701 should be modified (e.g., the list is incomplete or includes unnecessary forms), the user can modify the list 701. For example, the user can add a document to the list by selecting the “Add Form” button 711. An example of a UI for adding a document to the list 701 is provided in FIG. 8. In the UI of FIG. 8, a user can scroll through a list of documents 801 stored in the document store 211 and manually select one or more documents to add to the documents required for completing the automotive transaction. After the documents are selected, the document filler module 207 may populate fields of the newly selected documents.

Referring back to FIG. 2, in one embodiment, the user profile store 213 stores customer information. The customer information may be provided by a customer (e.g., submitted via a user device 109). In one embodiment, the user profile store 213 includes user profiles describing customers. These provides may include a customer's name, address, biographic (e.g., age and sex), demographic, and other types of descriptive information, such as work experience, salary information, credit information, educational history, hobbies, and the like.

The dealership store 215 includes information associated with the dealership, such as the address of the dealership. Other examples of information in the dealership store 215 include employee data (e.g., employee names and employee state license ID numbers (e.g., for states that require licenses to sell vehicles)), dealership business identification information, and an OEM franchise ID number. The vehicle store 217 includes inventory information about vehicles offered for sale by the dealership system 103. That is, the vehicle store 217 stores inventory information describing a list of vehicles offered for sale by the dealership system 103. For each vehicle included in the inventory information, the inventory information includes the make, model, year, mileage, and vehicle history. The other modules of the document recommendation module 201, such as the rule engine module 205 and the document filler module 207, may have access to information stored in the user profile store 213, the dealership profile store 215, and the vehicle store 217.

After documents are selected by the rule engine module 205 and completed by the document filler module 207, the documents may be provided to the user (e.g., an employee) via the UI. The UI allows the user to review the documents for accuracy and completeness. To complete the automotive transaction, the customer may be required to sign one or more of the selected documents. In one embodiment, after reviewing the documents, the customer can electronically sign the selected documents. Alternatively, the documents may be signed by the customer after the documents are printed. Note that the customer does not need to be physically present at the dealership system 103 to sign the selected documents. For example, a customer electronically signs the documents while at a location different from the automotive dealership (e.g., the customer's home).

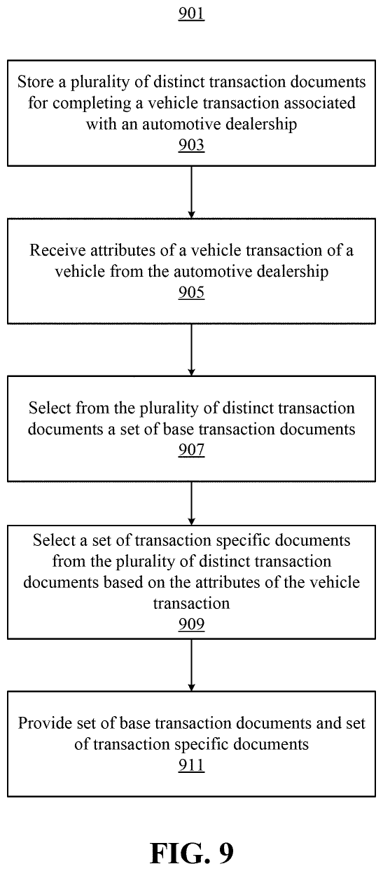

FIG. 9 is a flowchart of a method 901 of completing an automotive transaction associated with or at an automotive dealership. The steps of method 901 may be performed in different orders, and the method may include different, additional, or fewer steps.

A plurality of distinct transaction documents for completing automotive transactions at the automotive dealership are stored 903. In one embodiment, a selection rule describing attributes for selecting a document is received for each document in the plurality of distinct documents. The selection rule may be received from an employee of the automotive dealership. In one embodiment, a modification to the selection rule of at least one of the plurality of distinct documents from the employee is received.

In one embodiment, the plurality of distinct transaction documents include a Department of Motor Vehicles form, a state disclosure form, a lender disclosure form, a contract, a dealership compliance form, a purchase order form, a delivery form, an original equipment manufacturer form, and a registration and titling form.

Attributes of an automotive transaction of a vehicle from the automotive dealership are received 905 (e.g., from an employee of the automotive dealership). The attributes describe a type of transaction associated with the automotive transaction. In one embodiment, the received attributes of the automotive transaction further describe a location of the automotive dealership. In some embodiments, the attributes are received by a customer (e.g., via a user device 109).

A set of base transaction documents required to complete the automotive transaction are selected 907 from the plurality of distinct transaction documents. The set of base transaction documents is selected irrespective of the attributes of the automotive transaction.

A set of transaction specific documents from the plurality of distinct transaction documents is selected 909 based on the attributes of the automotive transaction. In one embodiment, at least one document in the set of transaction specific documents is selected based on the type of transaction specified by the attributes. The type of transaction may be a vehicle purchase or a vehicle lease.

In one embodiment, selecting the set of transaction specific documents includes additional steps. Responsive to the type of transaction being the vehicle purchase, a first set of transaction specific documents from the plurality of distinct transaction documents is selected based on the automotive transaction being the vehicle purchase. The first set of transaction specific documents from the plurality of distinct transaction documents may be selected further based on whether a loan is required to purchase the vehicle or if a total cost of the vehicle is being paid with cash. Responsive to the type of transaction being the vehicle lease, a second set of transaction specific documents from the plurality of distinct transaction documents is selecting based on the automotive transaction being the vehicle lease. The second set of transaction specific documents is distinct from the first set of transaction specific documents.

In one embodiment, selecting the set of transaction specific documents includes identifying documents from the plurality of transaction documents having selection rules that match the received attributes of the automotive transaction, and selecting the identified documents as the set of transaction specific documents for the automotive transaction.

The set of base transaction documents and the set of transaction specific documents are provided 911. Fields of the set of base transaction documents and the set of transaction specific documents are filled with values. The sets may be provided to the employee of the automotive dealership.

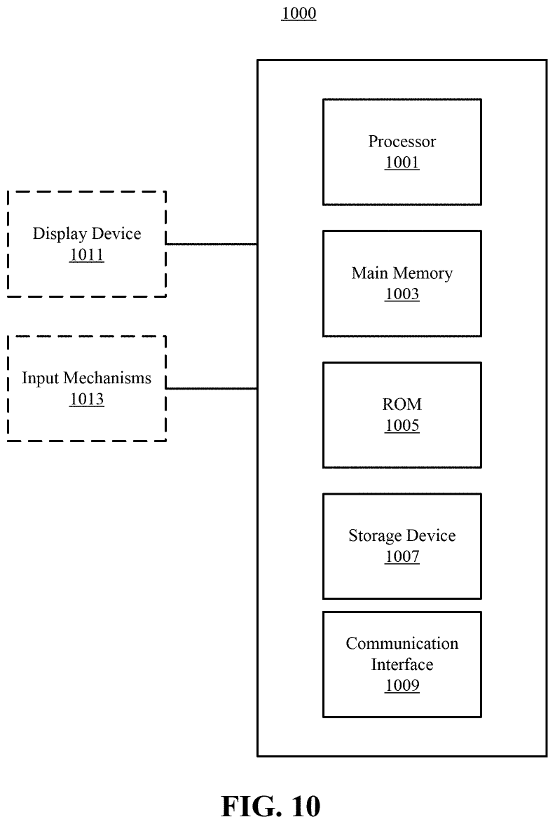

FIG. 10 is a diagram illustrating a computer system 1000 upon which embodiments described herein may be implemented within the management system 101, dealership system 103, third-party service system 105, dealership device 107, and user device 109. For example, in the context of FIG. 1, the management system 100, dealership system 103, third-party service system 105, dealership device 107, and user device 109 may each be implemented using a computer system such as described by FIG. 10. The management system 101 and/or dealership system 103 may also be implemented using a combination of multiple computer systems as described by FIG. 10.

In one implementation, the management system 100, dealership system 103, third-party service system 105, dealership device 107, and user device 109 each include processing resources 1001, main memory 1003, read only memory (ROM) 1005, storage device 1007, and a communication interface 1009. The management system 100, dealership system 103, third-party service system 105, dealership device 107, and user device 109 includes at least one processor 1001 for processing information and a main memory 1003, such as a random access memory (RAM) or other dynamic storage device, for storing information and instructions to be executed by the processor 1001. In one embodiment, multiple processors are employed by the dealership system 103 to perform the techniques described above in order to improve efficiency of the dealership system 103 and reduce computation time when generating the customized recommendations. Main memory 1003 also may be used for storing temporary variables or other intermediate information during execution of instructions to be executed by processor 1001. Management system 100, dealership system 103, third-party service system 104, dealership device 107, and user device 109 may each also include ROM 1005 or other static storage device for storing static information and instructions for processor 1001. The storage device 1007, such as a magnetic disk or optical disk or solid state memory device, is provided for storing information and instructions.

The communication interface 1009 can enable each of the management system 100, dealership system 103, third-party service system 104, dealership device 107, and user device 109 to communicate with each other through use of a communication link (wireless or wireline). Each of the management system 100, dealership system 103, third-party service system 104, dealership device 107, and user device 109 can optionally include a display device 1011, such as a cathode ray tube (CRT), an LCD monitor, an LED monitor, OLED monitor, a TFT display or a television set, for example, for displaying graphics and information to a user. An input mechanism 1013, such as a keyboard that includes alphanumeric keys and other keys, can optionally be coupled to the computer system 1000 for communicating information and command selections to processor 1001. Other non-limiting, illustrative examples of input mechanisms 1013 include a mouse, a trackball, touch-sensitive screen, or cursor direction keys for communicating direction information and command selections to processor 1001 and for controlling cursor movement on display device 1011.

Examples described herein are related to the use of the management system 100, dealership system 103, third-party service system 104, dealership device 107, and user device 109 for implementing the techniques described herein. According to one embodiment, those techniques are performed by each of the management system 100, dealership system 103, third-party service system 104, dealership device 107, and user device 109 in response to processor 1001 executing one or more sequences of one or more instructions contained in main memory 1003. Such instructions may be read into main memory 1003 from another machine-readable medium, such as storage device 1007. Execution of the sequences of instructions contained in main memory 1003 causes processor 1001 to perform the process steps described herein. In alternative implementations, hard-wired circuitry may be used in place of or in combination with software instructions to implement examples described herein. Thus, the examples described are not limited to any specific combination of hardware circuitry and software. Furthermore, it has also proven convenient at times, to refer to arrangements of operations as modules, without loss of generality. The described operations and their associated modules may be embodied in software, firmware, hardware, or any combinations thereof.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects disclosed herein include process steps and instructions described herein in the form of a method. It should be noted that the process steps and instructions described herein can be embodied in software, firmware or hardware, and when embodied in software, can be downloaded to reside on and be operated from different platforms used by a variety of operating systems.

The embodiments discussed above also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the embodiments are not described with reference to any particular programming language. It will be appreciated that a variety of programming languages may be used to implement the teachings described herein, and any references below to specific languages are provided for disclosure of enablement and best mode.

While the disclosure has been particularly shown and described with reference to a preferred embodiment and several alternate embodiments, it will be understood by persons skilled in the relevant art that various changes in form and details can be made therein without departing from the spirit and scope of the invention.

What is claimed is:

1. A computer-implemented method of completing an automotive transaction at an automotive dealership, the computer-implemented method comprising:
storing a plurality of distinct transaction documents used for completing automotive transactions associated with the automotive dealership;
receiving attributes of an automotive transaction of a vehicle from the automotive dealership, the attributes describing a type of transaction associated with the automotive transaction;
selecting from the plurality of distinct transaction documents a set of base transaction documents required to complete the automotive transaction, the selection of the set of base transaction documents irrespective of the attributes of the automotive transaction;
selecting a set of transaction specific documents from the plurality of distinct transaction documents based on the attributes of the automotive transaction; and
providing the set of base transaction documents and the set of transaction specific documents, fields of the set of base transaction documents and the set of transaction specific documents filled with values.

2. The computer-implemented method of claim 1, wherein at least one document in the set of transaction specific documents is selected based on the type of transaction specified by the attributes.

3. The computer-implemented method of claim 2, wherein the type of transaction is a vehicle purchase or a vehicle lease.

4. The computer-implemented method of claim 3, wherein selecting the set of transaction specific documents comprises:
responsive to the type of transaction being the vehicle purchase, selecting a first set of transaction specific documents from the plurality of distinct transaction documents based on the automotive transaction being the vehicle purchase; and
responsive to the type of transaction being the vehicle lease, selecting a second set of transaction specific documents from the plurality of distinct transaction documents based on the automotive transaction being the vehicle lease, the second set of transaction specific documents distinct from the first set of transaction specific documents.

5. The computer-implemented method of claim 4, wherein responsive to the type of transaction being the vehicle purchase, the first set of transaction specific documents from the plurality of distinct transaction documents is selected further based on whether a loan is required to purchase the vehicle or if a total cost of the vehicle is being paid with cash.

6. The computer-implemented method of claim 1, further comprising:
receiving, for each document in the plurality of distinct documents, a selection rule from an employee of the automotive dealership that describes attributes for selecting the document.

7. The computer-implemented method of claim 6, further comprising:
receiving a modification to the selection rule of at least one of the plurality of distinct documents from the employee.

8. The computer-implemented method of claim 1, wherein the plurality of distinct transaction documents include a Department of Motor Vehicles form, a state disclosure form, a lender disclosure form, a contract, a dealership compliance form, a purchase order form, a delivery form, an original equipment manufacturer form, a registration and titling form, a privacy form, a federal form, a dealership form, a vehicle form, an accessory purchase form, an insurance or protection form, a rebate and incentive form, and a trade-in vehicle form.

9. The computer-implemented method of claim 1, wherein selecting the set of transaction specific documents from the plurality of distinct transaction documents based on the attributes of the automotive transaction comprises:
identifying documents from the plurality of transaction documents having selection rules that match the received attributes of the automotive transaction; and
selecting the identified documents as the set of transaction specific documents for the automotive transaction.

10. The computer-implemented method of claim 1, wherein the received attributes of the automotive transaction further describe a location of the automotive dealership.

11. A non-transitory computer-readable storage medium storing executable computer program code that, when executed by one or more processors, cause the one or more processors to perform operations comprising:
storing a plurality of distinct transaction documents used for completing automotive transactions associated with an automotive dealership;
receiving attributes of an automotive transaction of a vehicle from the automotive dealership, the attributes describing a type of transaction associated with the automotive transaction;
selecting from the plurality of distinct transaction documents a set of base transaction documents required to complete the automotive transaction, the selection of the set of base transaction documents irrespective of the attributes of the automotive transaction;
selecting a set of transaction specific documents from the plurality of distinct transaction documents based on the attributes of the automotive transaction; and
providing the set of base transaction documents and the set of transaction specific documents, fields of the set of base transaction documents and the set of transaction specific documents filled with values.

12. The non-transitory computer-readable storage medium of claim 11, wherein at least one document in the set of transaction specific documents is selected based on the type of transaction specified by the attributes.

13. The non-transitory computer-readable storage medium of claim 12, wherein the type of transaction is a vehicle purchase or a vehicle lease.

14. The non-transitory computer-readable storage medium of claim 11, wherein the executable computer program code, when executed by one or more processors, causes the one or more processors to perform further operations comprising:
receiving, for each document in the plurality of distinct documents, a selection rule from an employee of the automotive dealership that describes attributes for selecting the document.

15. The non-transitory computer-readable storage medium of claim 14, wherein the executable computer program code, when executed by one or more processors, causes the one or more processors to perform further operations comprising:
receiving a modification to the selection rule of at least one of the plurality of distinct documents from the employee.

16. A computer system comprising:
one or more processors; and
a computer-readable storage medium comprising executable computer program code, the computer program code when executed causing the one or more processors to perform operations including:
storing a plurality of distinct transaction documents used for completing automotive transactions associated with an automotive dealership;
receiving attributes of an automotive transaction of a vehicle from the automotive, the attributes describing a type of transaction associated with the automotive transaction;
selecting from the plurality of distinct transaction documents a set of base transaction documents required to complete the automotive transaction, the selection of the set of base transaction documents irrespective of the attributes of the automotive transaction;
selecting a set of transaction specific documents from the plurality of distinct transaction documents based on the attributes of the automotive transaction; and
providing the set of base transaction documents and the set of transaction specific documents, fields of the set of base transaction documents and the set of transaction specific documents filled with values.

17. The computer system of claim 16, wherein at least one document in the set of transaction specific documents is selected based on the type of transaction specified by the attributes.

18. The computer system of claim 17, wherein the type of transaction is a vehicle purchase or a vehicle lease.

19. The computer system of claim 16, wherein the computer program code, when executed, causes the one or more processors to perform further operations including:
receiving, for each document in the plurality of distinct documents, a selection rule from an employee of the automotive dealership that describes attributes for selecting the document.

20. The computer system of claim 19, wherein the computer program code, when executed, causes the one or more processors to perform further operations including:
receiving a modification to the selection rule of at least one of the plurality of distinct documents from the employee.
